(19) United States
(12) Patent Application Publication
(10) Pub. No.: US 2025/0166387 A1
(43) Pub. Date: May 22, 2025

(54) MONITORING APPARATUS, MONITORING SYSTEM, MONITORING METHOD, AND NON-TRANSITORY COMPUTER READABLE MEDIUM

(71) Applicant: NEC Corporation, Minato-ku, Tokyo (JP)

(72) Inventors: Yuta NAMIKI, Tokyo (JP); Jianquan LIU, Tokyo (JP); Noboru YOSHIDA, Tokyo (JP); Ryo KAWAI, Tokyo (JP); Satoshi YAMAZAKI, Tokyo (JP); Tingting DONG, Tokyo (JP); Karen STEPHEN, Tokyo (JP); Youhei SASAKI, Tokyo (JP); Naoki SHINDOU, Tokyo (JP)

(73) Assignee: NEC Corporation, Minato-ku, Tokyo (JP)

(21) Appl. No.: 18/840,128

(22) PCT Filed: Mar. 3, 2022
(86) PCT No.: PCT/JP2022/009199

§ 371 Date: Aug. 21, 2024

(51) Int. Cl. G06V 20/54; G06Q 50/26; G06V 40/10

(52) U.S. Cl. CPC G06V 20/54; G06Q 50/265; G06V 40/10; G06V 2201/08

(57) ABSTRACT

The monitoring apparatus (101) includes an acquisition unit (102) and a processing unit (103). The acquisition unit (102) acquires external appearance information relating to an external appearance of a moving body included in an image captured by a plurality of photographing apparatuses (152) installed in a city. The processing unit (103) executes statistical processing by using the external appearance information.

### TECHNICAL FIELD

The present invention relates to a monitoring apparatus, a monitoring system, a monitoring method, and a storage medium.

### BACKGROUND ART

Patent Document 1 discloses a passing vehicle monitoring system including a plurality of surveillance cameras that are connected in series and capture an image of a passing state of a vehicle, and a center apparatus that is connected to the plurality of surveillance cameras. Each of the surveillance cameras includes a plurality of image capturing units, at least one spot light, an irradiation position change unit, a distance image generation unit, a stop object detection processing unit, a light illumination processing unit, and a light control unit.

The irradiation position change unit changes an irradiation position of the spot light. The distance image generation unit generates data relating to a distance image from a plurality of images being acquired by the plurality of image capturing units. The stop object detection processing unit detects a stop object, based on the distance image.

In a case where the stop object detection processing unit detects a stop object, the light illumination processing unit detects a position of the stop object, based on the distance image, and outputs a light illumination signal for irradiating the stop object with the light from the spot light.

The light control unit controls the irradiation position change unit, based on the light illumination signal, in order to change the irradiation position of the spot light to the position of the stop object, and execute control to illuminate the spot light.

Patent Document 2 discloses a monitoring system that detects a movement of a person photographed by a camera, decides “distracted walking”, and effectively issues a warning. In Patent Document 2, “distracted walking” refers to an act of walking inattentively while looking at a mobile phone, an electronic terminal (including a smartphone), or a book.

Note that, Patent Document 3 describes a technique of computing a feature value of each of a plurality of keypoints of a human body included in an image, searching for an image including a human body in a similar pose or a similar human body movement, based on the feature value being computed, and collectively classifying human bodies in the similar pose or movement. Further, Non-Patent Document 1 describes a technique relating to skeleton estimation of a person.

### Related Document

### Patent Document

Patent Document 1: Japanese Patent Application Publication No. 2012-103921
Patent Document 2: International Patent Publication No. WO2018/061616
Patent Document 3: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pp. 7291 to 7299

### DISCLOSURE OF THE INVENTION

### Technical Problem

In the techniques in Patent Documents 1 and 2, even though detection of a stop object, or detection of an act of walking inattentively while looking at a mobile phone or the like can be achieved, it is challenging to improve safety in a city from a macro perspective.

In view of the above-mentioned problem, one example of an object of the present invention is to provide a monitoring apparatus, a monitoring system, a monitoring method, and a storage medium that improves safety in a city.

### Solution to Problem

According to one aspect of the present invention, there is provided a monitoring apparatus including:
an acquisition unit that acquires external appearance information relating to an external appearance of a moving body included in an image captured by a plurality of photographing apparatuses installed in a city; and
a processing unit that executes statistical processing by using the external appearance information.

According to one aspect of the present invention, there is provided a monitoring system including:
the monitoring apparatus described above;
the plurality of photographing apparatuses; and
at least one terminal to be connected to the plurality of photographing apparatuses, wherein the terminal transmits the external appearance information to the monitoring apparatus.

According to one aspect of the present invention, there is provided a monitoring method including,
by a computer executing:
   acquiring external appearance information relating to an external appearance of a moving body included in an image captured by a plurality of photographing apparatuses installed in a city; and
   executing statistical processing by using the external appearance information.

According to one aspect of the present invention, there is provided a storage medium configured to store a program for causing a computer to:
acquire external appearance information relating to an external appearance of a moving body included in an image captured by a plurality of photographing apparatuses installed in a city; and
execute statistical processing by using the external appearance information.

### Advantageous Effects of Invention

According to the present invention, it is possible to assist improvement of safety in a city.

### BRIEF DESCRIPTION OF THE DRAWINGS

FIG. 1 is a diagram illustrating an overview of a monitoring system according to a first example embodiment.

FIG. 2 is a flowchart illustrating an overview of monitoring processing according to the first example embodiment.

FIG. 3 is a diagram illustrating a detailed example of the monitoring system according to the first example embodiment.

FIG. 4 is a diagram illustrating one example of a configuration of external appearance information according to the present example embodiment.

FIG. 5 is a diagram illustrating a functional configuration example of a processing unit according to the present example embodiment.

FIG. 6 is a diagram illustrating one example of event information according to the present example embodiment.

FIG. 7 is a diagram illustrating a physical configuration example of a monitoring apparatus according to the first example embodiment.

FIG. 8 is a flowchart illustrating one example of terminal processing according to the first example embodiment.

FIG. 9 is a flowchart illustrating one example of monitoring processing according to the first example embodiment.

FIG. 10 is a flowchart illustrating a detailed example of acquisition processing according to the first example embodiment.

FIG. 11 is a flowchart illustrating a detailed example of first processing according to the first example embodiment.

FIG. 12 is a diagram illustrating one example of detection information.

FIG. 13 is a diagram illustrating a configuration example of a monitoring system according to a second example embodiment.

FIG. 14 is a diagram illustrating a functional configuration example of terminal according to the second example embodiment.

FIG. 15 is a diagram illustrating one example of a configuration of external appearance information according to the second example embodiment, where (a) illustrates an example of first information, and (b) illustrate is an example of second information.

FIG. 16 is a diagram illustrating a functional configuration example of a processing unit according to the second example embodiment.

FIG. 17 is a flowchart illustrating one example of terminal processing according to the second example embodiment.

FIG. 18 is a flowchart illustrating a detailed example of processing at the time of detection according to the second example embodiment.

FIG. 19 is a flowchart illustrating one example of monitoring processing according to the second example embodiment.

FIG. 20 is a flowchart illustrating a detailed example of first processing according to the second example embodiment.

FIG. 21 is a diagram illustrating a configuration example of a monitoring system according to a third example embodiment.

FIG. 22 is a diagram illustrating a functional configuration example of a processing unit according to the third example embodiment.

FIG. 23 is a flowchart illustrating one example of an event update processing according to the third example embodiment.

### EXAMPLE EMBODIMENT

One example embodiment of the present invention is described below with reference to the drawings. Note that, in all the drawings, a similar constituent element is denoted with a similar reference sign, and description therefor is omitted as appropriate.

### First Example Embodiment

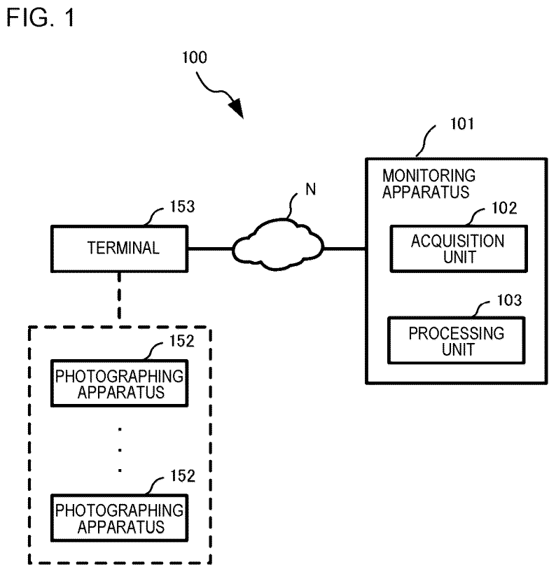

FIG. 1 is a diagram illustrating an overview of a monitoring system 100 according to a first example embodiment. The monitoring system 100 includes a monitoring apparatus 101, a plurality of photographing apparatuses 152, and at least one terminal 153 that is connected to the plurality of photographing apparatuses 152.

The monitoring apparatus 101 includes an acquisition unit 102 and a processing unit 103. The acquisition unit 102 acquires external appearance information relating to an external appearance of a moving body included in an image photographed by the plurality of photographing apparatuses 152 installed in a city. The processing unit 103 executes statistical processing by using the external appearance information.

The terminal 153 transmits the external appearance information to the monitoring apparatus.

According to the monitoring system 100, it is possible to assist improvement of safety in a city. According to the monitoring apparatus 101, it is possible to assist improvement of safety in a city.

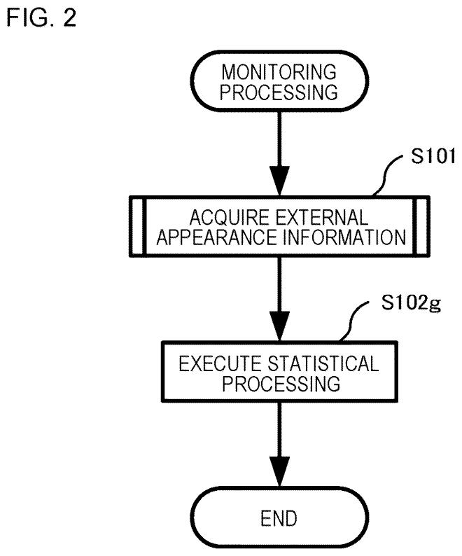

FIG. 2 is a flowchart illustrating an overview of monitoring processing according to the first example embodiment.

The acquisition unit 102 acquires the external appearance information relating to the external appearance of the moving body included in the image photographed by the plurality of photographing apparatuses 152 installed in a city (step S101). The processing unit 103 executes the statistical processing by using the external appearance information (step S102g).

According to the monitoring processing, it is possible to assist improvement of safety in a city.

Hereinafter, description is made on a detailed example of the monitoring system 100 according to the first example embodiment.

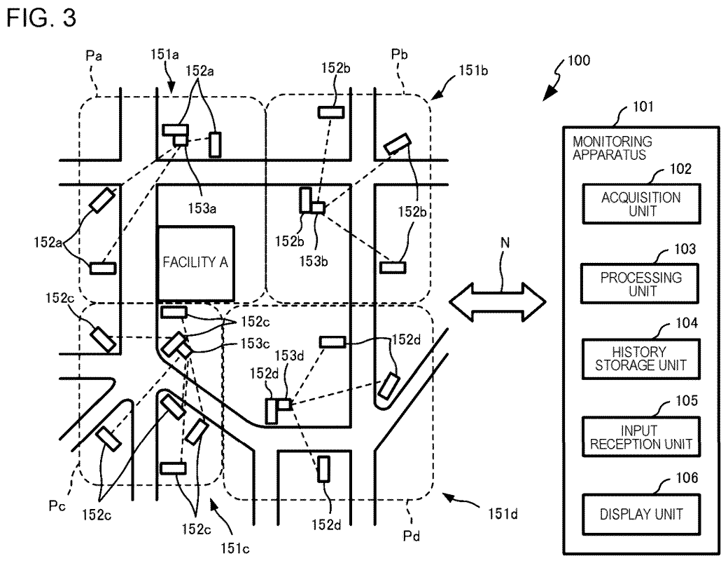

FIG. 3 is a diagram illustrating the detailed example of the monitoring system 100 according to the first example embodiment. The monitoring system 100 is a system for monitoring a city. The monitoring system 100 includes the monitoring apparatus 101 and four terminal systems 151a to 151d.

The monitoring apparatus 101 and each of the terminal systems 151a to 151d are connected to each other via a network N, and mutually transmit and receive information via the network N. The network N is a communication network being wired, wireless, or a combination thereof.

### Configuration Example of Terminal System 151

Each of the terminal systems 151a to 151d is a system that photographs a city and transmits, to the monitoring apparatus 101, external appearance information relating to an external appearance of a moving body included in the image being photographed. The terminal systems 151a to 151d include a plurality of photographing apparatuses 152a to 152d and the terminals 153a to 153d, respectively.

The numbers of photographing apparatuses 152a to 152d that are included in the terminal systems 151a to 151d, respectively, may be different from each other as long as the photographing apparatuses 152a to 152d each include at least one photographing apparatus. In a case where the terminal systems 151a to 151d are not distinguished from one another, each of them is also referred to as a terminal system 151.

The plurality of photographing apparatuses 152a to 152d are apparatuses that photograph a city. For example, each of the photographing apparatuses 152a to 152d is a camera installed in a city. Each of the photographing apparatuses 152a to 152d generates image information including an image being photographed.

In FIG. 3, the plurality of photographing apparatuses 152a to 152d are provided to photograph roads in monitoring regions Pa to Pd being decided as appropriate. Specifically, for example, the photographing regions of the photographing apparatuses 152a are regions that are decided in advance within the monitoring region Pa, and are at least partially different from each other. This similarly applies to the photographing apparatuses 152b to 152d.

Each of the photographing apparatuses 152a to 152d is an example of the photographing apparatus 152 described above, and may be configured similarly thereto. In a case where the photographing apparatuses 152a to 152d are not distinguished from one another, each of them is also referred to as a photographing apparatus 152.

Further, in a case where the monitoring regions Pa to Pd are not distinguished from one another, each of them is also referred to as a monitoring region P. Note that, the plurality of photographing apparatuses 152 may photograph not only a road but also various facilities, structures, buildings, and the like.

The terminals 153a to 153d acquire the image information including the image being photographed by each of the photographing apparatuses 152a to 152d, from the plurality of photographing apparatuses 152a to 152d included is the common terminal systems 151a to 151d via a communication line. The communication line may be a part of the network N, or may be a line different from the network N. Each of the terminals 153a to 153d generates the external appearance information, based on the image information being acquired, and it to the monitoring apparatus 101 via the network N.

The external appearance information is information relating to the external appearance of the moving body included in the image being photographed by the plurality of photographing apparatuses 152. The moving body is an object moving within the monitoring region P, and includes at least one of a person and a vehicle. In the present example embodiment, description is made while giving an example in which the moving body is a person and a vehicle.

The external appearance of the moving body is included in the image being photographed by the plurality of photographing apparatuses 152. Thus, as one example of the external appearance information, the information including the image being photographed by the plurality of photographing apparatuses 152 can be exemplified. In the present example embodiment, description is made while giving an example in which the external appearance information includes the image being photographed by the plurality of photographing apparatuses 152.

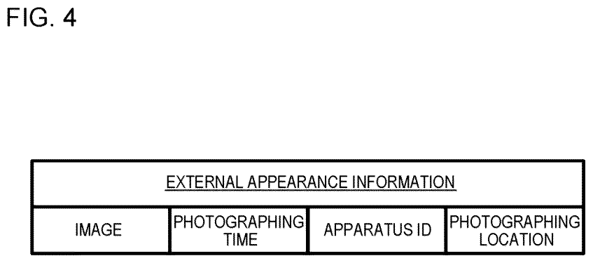

FIG. 4 is a diagram illustrating one example of a configuration of the external appearance information according to the present example embodiment. In the external appearance information illustrated in the drawing, the image, a photographing time, an apparatus identifier (ID), and a photographing location are associated with each other.

The image included in the external appearance information is an image photographed by the photographing apparatus 152. The photographing time is a time at which the image associated therewith is photographed. The apparatus ID is information for identifying the photographing apparatus 152 photographing the image associated therewith. For example, the apparatus ID is an address of the photographing apparatus 152 in the terminal system 151. The photographing location indicates a location where the image associated therewith is photographed. For example, the photographing location is an address of a region (photographing region) photographed by the photographing apparatus 152, and is set in advance in association with the photographing apparatus 152, in each of the terminals 153a to 153d . . .

In a case where the image information is acquired from the plurality of photographing apparatuses 152a to 152d, each of the terminals 153a to 153d associates the image included in the image information, the time at which the image information is acquired, and the apparatus ID of the photographing apparatus 152 with one another. As a result, each of the terminals 153a to 153d generates the external appearance information having a configuration illustrated in FIG. 4. Each of the terminals 153a to 153d transmits the external appearance information being generated to the monitoring apparatus 101.

Each of the terminals 153a to 153d is an example of the terminal 153 described above, and may be configured similarly thereto. In a case where the terminals 153a to 153d are not distinguished from one another, each of them is also referred to as a terminal 153.

Note that, any one of the plurality of photographing apparatuses 152 included in the common terminal system 151 may also include the function of the terminal 153. Further, each of the plurality of photographing apparatuses 152 may also include the function of the terminal

### Configuration Example of Monitoring Apparatus 101

As illustrated in FIG. 3, the monitoring apparatus 101 is an apparatus for monitoring a city. The monitoring apparatus 101 includes the acquisition unit 102, the processing unit 103, a history storage unit 104, an input reception unit 105, and a display unit 106, in a functional sense. The history storage unit 104 is a storage unit that stores a history of the external appearance information. The input reception unit 105 receives an input from a user. The display unit 106 displays various types of information.

The acquisition unit 102 acquires the external appearance information relating to the external appearance of the moving body from the terminal 153 via the network N. The acquisition unit 102 causes the history storage unit 104 to store the external appearance information being acquired.

As described above, the processing unit 103 executes the statistical processing by using the external appearance information. For example, the processing unit 103 executes the statistical processing, based on at least one of an attribute of the location where the image is photographed, a time zone in which the image is photographed, and an attribute of the moving body included in the image.

The processing unit 103 according to the present example embodiment analyzes the image included in the external appearance information, acquires at least one of an external appearance feature value of an attribute of the moving body, and executes the statistical processing by using at least one of the external appearance feature value and the attribute of the moving body.

The processing unit 103 according to the present example embodiment detects a moving body relevant to an event being set in advance, based on the result of analyzing the image included in the external appearance information. Further, the processing unit 103 further executes the statistical processing by using the detection result of the moving body relevant to the event being set in advance.

Details of the function of the processing unit 103 are described below.

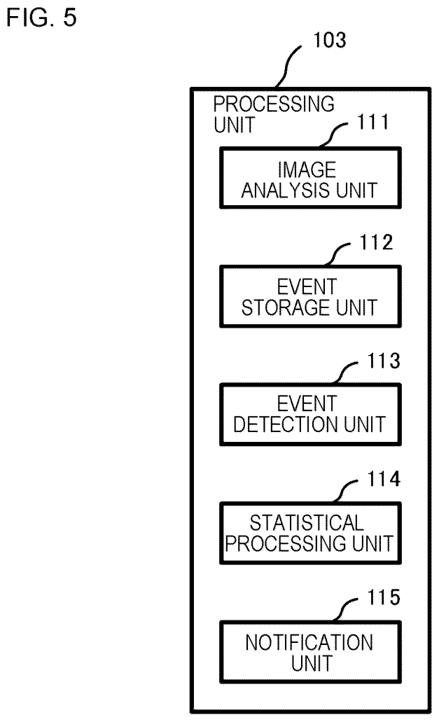

FIG. 5 is a diagram illustrating a functional configuration example of the processing unit 103 according to the present example embodiment. The processing unit 103 includes an image analysis unit 111, an event storage unit 112, an event detection unit 113, a statistical processing unit 114, and a notification unit 115.

The image analysis unit 111 analyzes the image photographed by the photographing apparatus 152, and acquires the external appearance feature value and the attribute of the moving body.

Further, the image analysis unit 111 causes the history storage unit 104 to store the external appearance feature value and the attribute of the moving body that are acquired. In this state, the image analysis unit 111 causes the history storage unit 104 to store the external appearance feature value and the attribute of the moving body, in association with the image from which those are acquires. Note that, the image analysis unit 111 may analyze the image photographed by the photographing apparatus 152, and may acquire one of the external appearance feature value and the attribute of the moving body.

### External Appearance Feature Value of Moving Body

The external appearance feature value of the moving body is a feature value relating to the external appearance of the moving body. The external appearance feature value of the moving body is a feature value being acquired from the image including the moving body.

For example, the external appearance feature value of the moving body includes a feature value relating to at least one of an external appearance attribute of the moving body, a pose of the moving body, and a movement of the moving body.

For example, the feature value relating to the external appearance attribute of the moving body is at least one of an external appearance attribute feature value, which is described later, a color and a size of a vehicle, and the like. For example, the feature value relating to the pose of the moving body is at least one of a pose feature value, which is described later, orientation of a vehicle, and the like. For example, the feature value relating to the movement of the moving body is at least one of a movement feature value, which is described later, a flow line of the moving body, a moving speed of the moving body, and the like.

### (Attribute of Moving Body)

In a case where the moving body is a person, the attribute thereof is at least one of an age group, a gender, an individual needing assistance, a person walking while distracted, a police officer, a person being alone or acting alone, and the like.

An individual needing assistance is an individual who needs assistance, such as a person in a wheel-chair and a person using a cane. For example, the image analysis unit 111 detects a person in a wheel-chair or a person carrying a cane, and thus detects an individual needing assistance.

A person walking while distracted is at least one of a person walking while operating or browsing a mobile terminal, a smartphone, or the like, a person walking while smoking, and the like. The image analysis unit 111 detects a person walking while holding a mobile terminal, a smartphone, a cigarette, or the like, and thus detects a person walking while distracted. In a case where a person walking while operating or browsing a mobile terminal, a smartphone, or the like is to be detected, the image analysis unit 111 may further detect a person walking while distracted, based on a face of a person facing downward.

For example, in a case where the moving body is a vehicle, the attribute thereof is at least one of a private car, a taxi, a truck, an emergency vehicle (a police car, an ambulance, a fire truck, and the like), a motorcycle, a bicycle, and the like. An attribute of a vehicle may include a vehicle type. For example, the image analysis unit 111 may acquire an attribute of a vehicle, based on a shape, a color, a size, or the like of a vehicle.

### (Analysis Function)

The image analysis unit 111 includes an image analysis function in order to acquire the external appearance feature value and the attribute of the moving body. The image analysis function is a function of analyzing an image.

For example, the analysis function included in the image analysis unit 111 includes one or a plurality of (1) an object detection function, (2) a face analysis function, (3) a human shape analysis function, (4) a pose analysis function, (5) an action analysis function, (6) an external appearance attribute analysis function, (7) a gradient feature analysis function, (8) a color feature analysis function, (9) a flow line analysis function, and the like.

(1) In the object detection function, an object is detected from an image. In the object detection function, a position, a size, and the like of the object in the image can also be acquired. An example of a model to be applied to object detection processing includes you only look once (YOLO). The object includes a person and an item. For example, in the object detection function, a moving body, a neglected object on a road, a wheel-chair, a cane (including crutches and a white cane), a mobile terminal, a smartphone, a cigarette, and the like are detected. Further, for example, in the object detection function, a position of a moving body, a neglected object on a road, a wheel-chair, or the like is acquired.

(2) In the face analysis function, detection of a face of a person from an image, extraction of a feature value of the face being detected (face feature value), categorization (classification) of the face being detected, and the like are executed. In the face analysis function, a position of the face in the image can also be acquired. In the face analysis function, identity of a person being detected from different images can also be decided based on a similarity degree of face feature values of the person being detected from the different images, or the like.

(3) In the human shape analysis function, extraction of a human body feature value (for example, a value indicating an overall feature such as a body shape such as obese or thin, a height, and clothes) of a person included in an image, categorization (classification) of the person included in the image, and the like are executed. In the human shape analysis function, a position of the person in the image can also be determined. In the human shape analysis function, identity of a person included in different images can also be decided based on the human body feature values of the person included in the different images, or the like.

(4) In the pose analysis function, a stick figure model is generated by detecting joints of a person from an image and connecting the joints to each other. Further, in the pose analysis function, estimation of a pose of a person, extraction of a feature value of the pose being estimated (pose feature value), categorization (classification) of the person included in the image, and the like are executed by using information relating to the stick figure model. In the pose analysis function, identity of a person included in different images can also be decided based on the pose feature values of the person included in the different images, or the like

For example, in the pose analysis function, a pose such as a standing position, a squatting pose, and a crouching pose is estimated from an image, and the pose feature value indicating each of the poses is extracted. Further, for example, in the pose analysis function, a pose with respect to an item being detected by using the object detection function or the like is estimated from an image, and the pose feature value indicating the pose can be extracted

For example, the techniques disclosed in Patent Document 3 and Non-Patent Document 1 are applicable to the pose analysis function.

(5) In action analysis processing, a movement of a person is estimated by using information relating to a stick figure model, a change of a pose, or the like, and extraction of a feature value of the movement of the person (movement feature value), categorization (classification) of the person included in the image, and the like can be executed. In the action analysis processing, by using the information relating to the stick figure model, a height of the person can also be estimated, and a position of the person in the image can also be determined. For example, in the action analysis processing, an action such as a change or transition of a pose, and a moving action (a change or transition of a position) can be extracted from an image, and a movement feature value of the action can be extracted.

(6) In the external appearance attribute analysis function, an external appearance attribute associated with a person can be recognized. In the external appearance attribute analysis function, extraction of a feature value relating to the external appearance attribute being recognized (external appearance attribute feature value), categorization (classification) of the person being included in an image, and the like are executed. The external appearance attribute is an attribute relating to an external appearance, and includes, for example, one or more of a color of clothes, a color of a shoe, a hair style, a hat or a necktie, wearing of glasses, and the like. Further, for example, the external appearance attribute may include a uniform of a police officer and the like.

(7) In the gradient feature analysis function, a feature value of a gradient (gradient feature value) in an image is extracted. For example, techniques such as SIFT, SURF, RIFF, ORB, BRISK, CARD, and HOG are applicable to gradient feature detection processing.

(8) In the color feature analysis function, an object can be extracted from an image, and extraction of a feature value of a color of the object being detected (color feature value), categorization (classification) of the object being detected, and the like can be executed. The color feature value is a color histogram, for example.

(9) In the flow line analysis function, a flow line (a trajectory of a moving action) of a moving body included in an image can be acquired by using a result of the identity decision, a result of the classification, and the like in any of the analysis functions (2) to (8) described above, for example. Specifically, for example, the flow line of a moving body can be acquired by connecting moving bodies being decided as the same moving body between different images in time series. Note that, in the flow line analysis function, in a case where a video being photographed by the plurality of photographing apparatuses 152 that photograph different photograph areas is acquired, a flow line over a plurality of images being acquired by photographing the different photograph areas can also be acquired.

The above-mentioned analysis functions included in the image analysis unit 111 may be configured in such a way that the analysis results can be used mutually therebetween. Further, the image analysis unit 111 may include a function (analysis function) of analyzing an image by using the above-mentioned analysis functions and acquiring an age group, a gender, a moving speed of a person, a pose (orientation) of a vehicle, a moving speed of a vehicle, or the like.

Note that, the analysis functions described herein are examples of a method of acquiring the external appearance feature value and the attribute of the moving body, and a method of acquiring the external appearance feature value and the attribute of the moving body is not limited thereto.

The event storage unit 112 is a storage unit that stores event information relating to the event being set in advance.

### Examples of Event Information

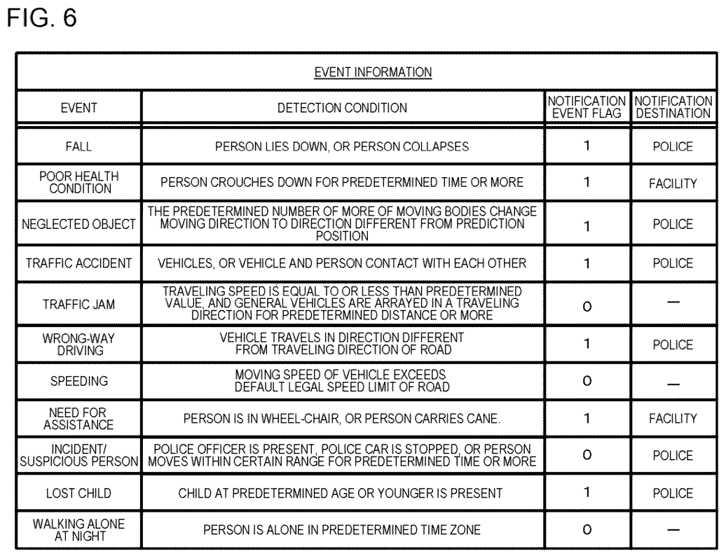

FIG. 6 is a diagram illustrating one example of the event information according to the present example embodiment. In the event information, an event, a detection condition, a notification event flag, and a notification destination are associated with one another. The detection condition is a condition for detecting an event associated therewith from an image.

For example, the event is set in advance in association with at least one of a pose, a movement, and an attribute of the moving body. The movement may include at least one of a position, a moving speed, a flow line, and the like, and also includes a state of being stationary. As illustrated in FIG. 6, specific examples of the event include a fall, a poor health condition, a neglected object, a traffic accident, a traffic jam, wrong-way driving, speeding, need for assistance, an incident/suspicious person, a lost child, walking alone at night, and the like.

For example, a fall is associated with a detection condition that a person lies down or a person collapses. For example, a poor health condition is associated with a detection condition that a person crouches down for a predetermined time or more. A fall and a poor health condition are examples of the event relating to a pose, a movement, and the like of a person.

For example, in a case where a neglected object is on a road or the like, the moving body such as a person or a vehicle changes a moving direction to avoid the neglected object. Thus, a neglected object is associated with a detection condition that the predetermined number or more of moving bodies change a moving direction to a direction different from a predication position. The prediction position is a position acquired by extrapolating a previous flow line in an advance direction with a linear line or a curbed line. A neglected object is an example of the event relating to a movement (flow line) of a moving body. Note that, the detection condition for a neglected object may be that an object is on a street for a predetermined time or more.

For example, a traffic accident is associated with a detection condition that vehicles, or a vehicle and a person contact with each other. A contact can be detected based on one or a plurality of sudden changes of a position, a pose (orientation) and the like. A traffic accident is an example of the event relating to a movement, a pose, and the like of a moving body.

For example, a traffic jam is associated with a detection condition that a traveling speed is equal to or less than a predetermined value and general vehicles are arrayed in a traveling direction for a predetermined distance or more. For example, the general vehicle is a vehicle other than a taxi, a truck, an emergency vehicle, a motorcycle, and a bicycle. For example, wrong-way driving is associated with a detection condition that a vehicle travels in a direction different from a traveling direction on a road. For example, speeding is associated with a detection condition that a moving speed of a vehicle exceeds a default legal speed limit of a road. A traffic jam, wrong-way driving, and speeding are examples of the event relating to a movement, an attribute, and the like of a vehicle.

For example, need for assistance indicates an event in which assistance is needed. Need for assistance is associated with a condition for detecting an individual needing assistance, as understood from the detection condition in FIG. 6. Need for assistance is an example of the event relating to an attribute and the like of a person. Note that, for example, the detection condition for need for assistance may be that a person in a wheel-chair is heading to a step or stairs.

For example, near a location where a police officer is present or a location where a police car is stopped, an incident is likely to occur, or a suspicious person is likely to be present. Further, a suspicious person may move within a certain range for a predetermined time or more. Thus, an incident/suspicious person is associated with a detection condition that a police officer is present, a police car is stopped, or a person moves within a certain range for a predetermined time or more. An incident/suspicious person is an example of the event relating to an attribute (a police officer), and the like of a person.

For example, a lost child is associated with a detection condition that a child at an age equal to or younger than a predetermined age is present alone for a predetermined time or more. For example, the predetermined age is ten. A lost child is an example of the event relating to an attribute and the like of a person (an age group, being alone).

For example, walking alone at night is associated with a detection condition that a person is alone in a predetermined time zone. For example, the predetermined time zone is from 23:00 to 4:00. Walking alone at night is an example of the event relating a movement, an attribute (being alone), and the like of a person.

The notification event flag is one example of notification event information indicating whether the event being associated therewith is a notification event. “1” of the notification event flag indicates that the event being associated therewith is a notification event. “0” of the notification event flag indicates that the event being associated therewith is not a notification event.

The notification event is an event to be notified to a predetermined notification destination in a case where it is detected. The notification event may be decided in advance from the events, and is an event that is desirably handled as soon as possible.

The notification destination is associated with the notification event. The notification destination is an institution to be notified of the notification event associated therewith.

In a case where the notification event is a fall, a neglected object, a traffic accident, wrong-way driving, an incident/suspicious person, or a lost child, such a notification event is generally handled by the police. Thus, in the example of notification information illustrated in FIG. 6, the notification destination associated with those notification events is the police. Further, in a case where the notification event is a poor health condition, or need for assistance, such a notification event is generally handled by a staff member of a facility, such as a station worker. Thus, in the example of the notification information illustrated in FIG. 6, the notification destination associated with those notification events is a facility.

Refer back to FIG. 5.

The event detection unit 113 detects the moving body relevant to the event being set in advance from the moving bodies included in the image, based on the result of analyzing the image by the image analysis unit 111 and the event information.

The result of analyzing the image by the image analysis unit 111 is an analysis result acquired by using the analysis function of the image analysis unit 111. Specifically, for example, the result of analyzing the image by the image analysis unit 111 includes at least one of the external appearance feature value and the attribute of the moving body.

In a case where the moving body relevant to the event being set in advance is detected, the event detection unit 113 generates detection information. The detection information is information indicating the detection result of the moving body relevant to the event being set in advance. The event detection unit 113 causes the history storage unit 104 to store the detection information being generated.

The statistical processing unit 114 executes the statistical processing by using at least one of the result of analyzing the image by the image analysis unit 111 and the moving body being detected by the event detection unit 113. The statistical processing unit 114 executes the statistical processing, based on at least one of the attribute of the location where the image is photographed, the time zone in which the image is photographed, and the attribute of the vehicle included in the image. The statistical processing unit 114 causes the display unit 106 to display the result of the statistical processing.

### Examples of Attribute of Location

The attribute of the location includes at least one of a feature of a location relating to passage of the moving body, an area, and the like.

A feature of a location relating to passage of a vehicle is at least one of an intersection, an intersection at which the number of intersecting roads or traffic lanes is equal to or more than the predetermined number, a curve, a road of a straight section of a predetermined length or more, and the like. A feature of a location relating to passage of a person is at least one of presence of a step, stairs, and the like.

For example, an area may be indicated by using a facility such as a station, a bus stop, a recreational facility, a park, a sport center, a convenience store, a supermarket, a shop, and a parking lot. An area may be indicated by using an address, for example, Chiyoda-ku, Tokyo or 1 Chome Kasumigaseki, Chiyoda-ku, Tokyo.

In a case where a moving body relevant to the notification event is detected, the notification unit 115 notifies the notification destination of detection of the notification event, the notification destination being decided in advance in association with the notification destination.

Specifically, for example, in a case where the moving body relevant to the notification event is detected, the notification unit 115 determines the notification destination associated with the notification event, based on the event information. The notification unit 115 transmits the detection information to an apparatus (omitted in illustration) provided at the notification destination being determined.

For example, the apparatus provided at the notification destination being determined is an apparatus provided to the notification destination closest to the notification event. The notification unit 115 may hold information in which a location of a notification destination and an apparatus (an address on the network N) are associated with each other, in advance, and may acquire the apparatus at the notification destination (the address on the network N) from an external apparatus (omitted in illustration) via the network N.

The functional configuration of the monitoring system 100 according to the first example embodiment is mainly described above. Hereinafter, description is made on a physical configuration of the monitoring system 100 according to the present example embodiment.

### (Physical Configuration of Monitoring System 100)

The monitoring system 100 is configured by the monitoring apparatus 101 and at least one terminal system 151 that are connected to each other via the network N, in a physical sense. The terminal system 151 is configured by the plurality of photographing apparatuses 152 and the terminal 153 that are connected to each other via the communication line, in a physical sense. The monitoring apparatus 101, each of the plurality of photographing apparatuses 152, and the terminal 153 are configured by single apparatuses that are different from one another in a physical sense.

Note that, any one of the plurality of photographing apparatuses 152 may be configured integrally with the terminal 153 in a physical sense. One or both of the monitoring apparatus 101 and the terminal 153 may be configured by a plurality of apparatuses that are connected via an appropriate communication line such as the network N, in a physical sense.

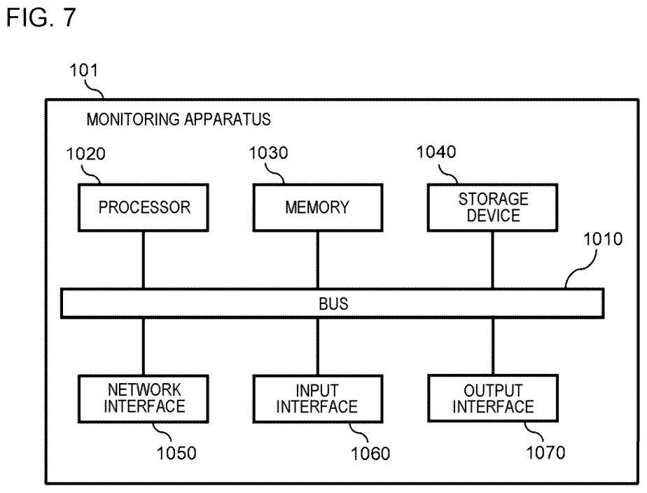

For example, the monitoring apparatus 101 is a general-purpose computer in a physical sense. FIG. 7 is a diagram illustrating a physical configuration example of the monitoring apparatus 101 according to the first example embodiment.

For example, the monitoring apparatus 101 includes a bus 1010, a processor 1020, a memory 1030, a storage device 1040, a network interface 1050, an input interface 1060, and an output interface 1070.

The bus 1010 is a data transmission path in which the processor 1020, the memory 1030, the storage device 1040, the network interface 1050, the input interface 1060, and the output interface 1070 transmit and receive data mutually. However, a method of connecting the processor 1020 and the like to one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a memory card, a read only memory (ROM), or the like. The storage device 1040 stores a program module achieving the function of the monitoring apparatus 101. The processor 1020 reads each of the program modules on the memory 1030 and executes the read program module, and thereby each of the functions associated with each of the program modules is achieved.

The network interface 1050 is an interface for connecting the monitoring apparatus 101 to the network N.

The input interface 1060 is an interface for inputting information by a user. For example, the input interface 1060 is configured by a touch panel, a keyboard, a mouse, or the like.

The output interface 1070 is an interface for providing information to a user. For example, the output interface 1070 is configured by a liquid crystal panel, an organic electro-luminescence (EL) panel, or the like.

For example, similarly to the monitoring system 100, the terminal 153 includes the bus 1010, the processor 1020, the memory 1030, the storage device 1040, the network interface 1050, the input interface 1060, and the output interface 1070 in a physical sense.

The storage device 1040 included in the terminal 153 stores a program module achieving the function of the terminal 153. The network interface 1050 included in the terminal 153 is an interface for connecting the terminal 153 to the network N. Except for those points, the terminal 153 may be configured similarly to the monitoring system 100 in a physical sense.

The physical configuration of the monitoring system 100 according to the first example embodiment is mainly described above. Hereinafter, description is made on an operation of the terminal system 151 according to the present example embodiment.

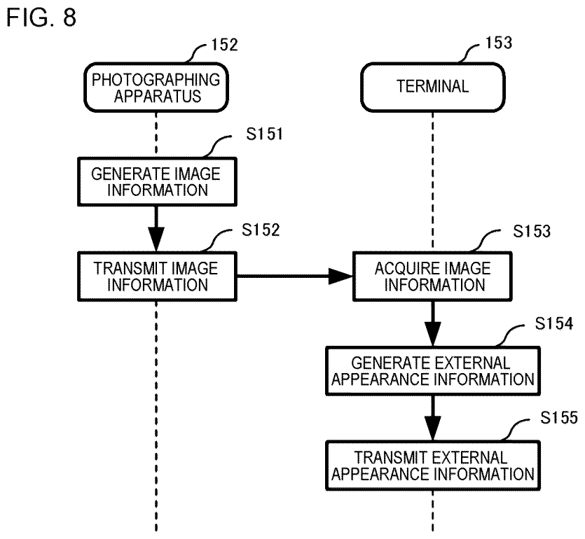

FIG. 8 is a flowchart illustrating one example of terminal processing according to the first example embodiment. The terminal processing is processing to be executed for photographing the monitoring region P by the terminal system 151 and transmitting the external appearance information relating to the external appearance of the moving body included in the image being photographed. For example, during an operation, the terminal system 151 repeatedly executes the terminal processing.

Each of the photographing apparatuses 152 photographs the photographing regions, and generates the image information including the image being photographed (step S151). Each of the photographing apparatuses 152 transmits the image information being generated in step S151 to the terminal 153 (step S152).

The terminal 153 acquires the image information being transmitted in step S152 (step S153). The terminal 153 generates the external appearance information, based on the image information being acquired in step S153 (step S154). The terminal 153 transmits the external appearance information being generated in step S154 to the monitoring apparatus 101 (step S155).

By executing the terminal processing, the terminal system 151 is capable of generating the external appearance information relating to the external appearance of the moving body, in substantially real time, and transmitting it to the monitoring apparatus 101.

Note that, in step S155, the terminal 153 may generate the external appearance information for all the pieces of the image information being generated by each of the photographing apparatuses 152, and may transmit it to the monitoring apparatus 101.

Further, in step S155, the terminal 153 may generate the external appearance information for the image information within, for example, a time interval being decided in advance, among all the pieces of the image information being generated by each of the photographing apparatuses 152, and transmits it to the monitoring apparatus 101. In this manner, a data amount transmitted to the monitoring apparatus 101 can be reduced by reducing part of the image information being generated by each of the photographing apparatuses 152 and generating and transmitting the external appearance information. With this, a communication load on the network N can be reduced.

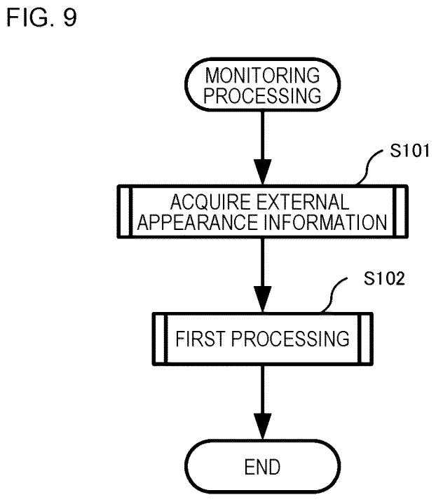

FIG. 9 is a flowchart illustrating one example of the monitoring processing according to the first example embodiment. The monitoring processing is processing to be executed for monitoring a city by the monitoring apparatus 101. For example, during an operation, the monitoring apparatus 101 repeatedly executes the monitoring processing.

As described above with reference to FIG. 2, the acquisition unit 102 acquires the external appearance information relating to the external appearance of the moving body included in the image being photographed by the plurality of photographing apparatuses 152 (step S101). The processing unit 103 executes first processing (step S102) including the statistical processing (step S102g) using the external appearance information described above with reference to FIG. 2.

Details of step S101 and step S102 are described with reference to the drawings.

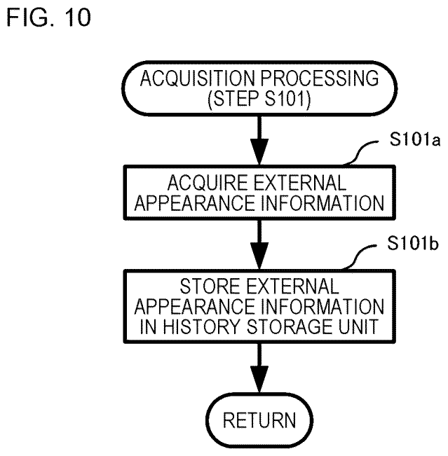

FIG. 10 is a flowchart illustrating a detailed example of acquisition processing according to the first example embodiment (step S101).

The acquisition unit 102 acquires the external appearance information relating to the external appearance of the moving body from the terminal 153 (step S101a). The acquisition unit 102 causes the history storage unit 104 to store the external appearance information being acquired in step S101a (step S101b), and returns to the monitoring processing (see FIG. 2).

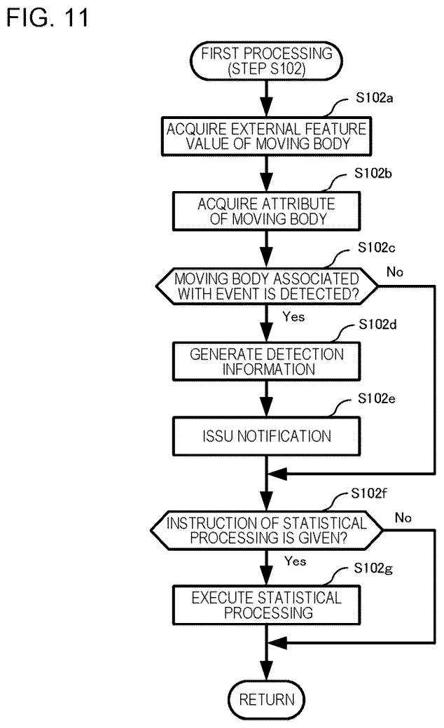

FIG. 11 is a flowchart illustrating a detailed example of the first processing according to the first example embodiment (step S102).

The image analysis unit 111 analyzes the image being acquired in step S101a, and acquires the external appearance feature value of the moving body (step S102a). The image analysis unit 111 analyzes the image being acquired in step S101a, and acquires the attribute of the moving body (step S102b). The image analysis unit 111 causes the history storage unit 104 to store the external appearance feature value and the attribute of the moving body that are acquired in step S102a and S102b, in association with the images associated therewith.

The event detection unit 113 decides whether the moving body relevant to the event being set in advance is detected from the moving bodies included in the image being acquired in step S101a (step S102c).

Specifically, for example, the event detection unit 113 detects the moving body relevant to the event being set in advance, based on the external appearance feature value and the attribute of the moving body that are acquired in step S102a and S102b and the event information being stored in the event storage unit 112. More specifically, for example, the event detection unit 113 detects the moving body relevant to the detection condition included in the event information, based on the external appearance feature value and the attribute of the moving body.

In a case where the moving body relevant to the event is detected (step S102c; Yes), the event detection unit 113 generates the detection information relating to the moving body being detected (step S102d).

The event detection unit 113 generates the detection information including the image to which the label indicating the event relevant to the moving body being detected is added. The event detection unit 113 causes the history storage unit 104 to store the detection information being generated.

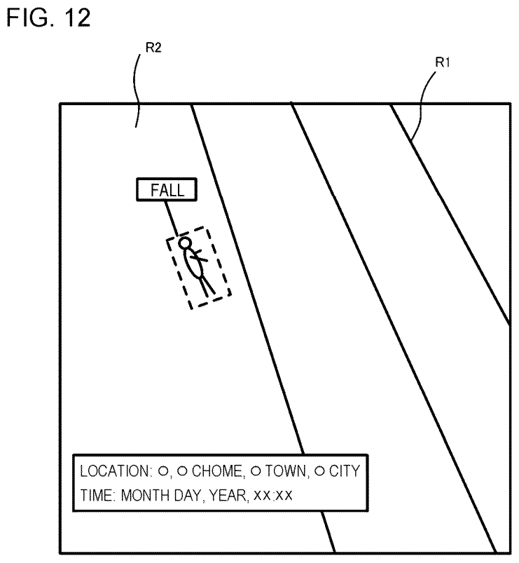

FIG. 12 is a diagram illustrating one example of the detection information. The drawing illustrates one example of the image included in the detection information in a case where the event “fall” is detected.

A person lies on a sidewalk R2 beside a roadway R1, and is marked with a dashed square frame. Further, a label “fall” is added in association with the frame. Further, information indicating the detection location and date is added. The detection location is a location where the image is photographed. The detection date is a date when the image is photographed.

Refer back to FIG. 11.

The notification unit 115 transmits the detection information to an institution associated with the event being detected, based on the notification information (step S102e).

For example, in a case where a moving body relevant to “fall”, “lost child”, “neglected object” or the like is detected, the notification unit 115 transmits the detection information being generated in step S102d to an apparatus of the police being an institution associated with “fall”, “lost child”, “neglected object” and the like, via the network N, for example.

Further, for example, in a case where a moving body relevant to “need for assistance” is detected, the notification unit 115 determines a railway or a facility closest to the location where “need for assistance” is detected, among railways or facilities being institutions associated with “need for assistance”. The notification unit 115 transmits the detection information being generated in step S102d to an apparatus of the facility being determined, via the network N, for example.

With such a notification, each of the events can be handled quickly. Therefore, it is possible to assist improvement of safety in a city.

In a case where the moving body relevant to the event is not detected (step S102c; No), or subsequently to step S102e, the statistical processing unit 114 decides whether an instruction of executing the statistical processing is given from a user (step S102f). For example, an instruction from a user is received by the input reception unit 105.

In a case where an instruction of executing the statistical processing is not given from a user (step S102f; No), the statistical processing unit 114 terminates the first processing (step S102), and terminates the monitoring processing (see FIG. 2).

In a case where an instruction of executing the statistical processing is given from a user (step S102f; Yes), the statistical processing unit 114 executes the statistical processing (step S102g), and terminates the monitoring processing (see FIG. 2).

In step S102g, the statistical processing unit 114 executes the statistical processing by using the external appearance feature value and the attribute of the moving body that are acquired in steps S102a and S102b and the detection result of the moving body relevant to the event in step S102c. In other words, the statistical processing unit 114 executes the statistical processing by using the external appearance feature value and the attribute of the moving body and the detection result of the moving body relevant to the event.

In this state, the statistical processing unit 114 may execute the statistical processing by using an external appearance feature value and an attribute of a moving body in an appropriate period among external appearance feature values and attributes of current and past moving bodies. Further, the statistical processing unit 114 may execute the statistical processing by using a detection result in an appropriate period among detection results of moving bodies relevant to present and current events. The statistical processing unit 114 can acquire the external appearance feature values and the attributes of the moving bodies in the past and the detection results in the past from the history storage unit 104.

Specifically, for example, the statistical processing unit 114 executes the statistical processing using the external appearance feature value and the attribute of the moving body and the moving body relevant to the event, based on the attribute of the location where the image is photographed, the time zone in which the image is photographed, and the attribute of the vehicle included in the image. The statistical processing unit 114 causes the display unit 106 to display the result of the statistical processing.

Specifically, for example, the statistical processing unit 114 aggregates the number of times for which each of the events such as “fall”, “lost child”, “traffic jam”, “distracted walking”, and the like is detected, by an attribute of a location or a time zone, for example, and causes the display unit 106 to display an image indicating the aggregation result. For example, by referring to the result, a cause of each of the events, a measure to prevent each of the events, a measure to quickly handle each of the events, and the like can be examined based on a location, a time zone, or the like in which each of the events such as “fall”, “lost child”, “a traffic jam”, “distracted walking”, and the like frequently occurs.

For example, in a case where a traffic jam is frequently caused due to an increase of the number of vehicles temporarily stopping around a station during a certain time zone in the evening, it is conceived to reinforce patrols in the time zone. For example, in a case where the number of lost children is increased near a certain facility on holidays, it is conceived to reinforce patrols in the facility on holidays. For example, in a case where the number of individuals needing assistance, who pass through a certain step or stairs, is equal to or more than the predetermined number, it may be examined to install a slope or install an elevator. For example, in a case where a large number of people walk while distracted in a certain facility in a specific time zone, it may be examined to take a measure such as broadcasting a warning for raising awareness in the facility in the time zone with a large number of people walking while distracted.

Further, Specifically, for example, the statistical processing unit 114 aggregates a traffic volume of one or both of vehicles and people by an attribute of a location, a time zone, a type of a vehicle, and the like, and causes the display unit 106 to display an image indicating the aggregation result. By referring to the result together with the result of the statistical processing relating to “traffic jam”, “traffic accident”, and the like, a cause of a traffic jam or a traffic accident, a measure to precent a traffic jam or a traffic accident, and the like can be examined based on an attribute of a location, an attribute of a vehicle, and the like in a time zone in which a traffic amount is increased or a traffic accident frequently occurs.

Moreover, specifically, for example, the statistical processing unit 114 aggregates a pedestrian traffic volume at a specific intersection by an age group, and causes the display unit 106 to display an image indicating the aggregation result. A walking speed differs depending on an age group, and hence a measure to manage safe crossing at the intersection, such as appropriate setting of a time duration of the green light for pedestrians at the intersection, can be taken by referring to the aggregation result.

As exemplified above, a measure can be examined based on the result of the statistical processing, and hence it is possible to assist improvement of safety in a city.

Moreover, specifically, for example, the statistical processing unit 114 aggregates clothing, a color of clothing, and the like by an attribute of a location, a time zone, and an age group, and causes the display unit 106 to display an image indicating the aggregation result. For example, by comparing the result with a similar aggregation result from the last year, it is possible to grasp trends in clothing for the year, transitions in seasons, transitions in sensory temperatures, and the like. With this, it is possible to provide information relating to trends, information relating to weather, and the like.

### Advantageous Effects

As described above, according to the present example embodiment, the monitoring apparatus 101 includes the acquisition unit 102 and the processing unit 103. The acquisition unit 102 acquires the external appearance information relating to the external appearance of the moving body included in the image photographed by the plurality of photographing apparatuses 152 installed in a city. The processing unit 103 executes the statistical processing by using the external appearance information.

With this, based on the result of the statistical processing, a measure can be taken for safety in a city from a macro perspective. Therefore, it is possible to assist improvement of safety in a city.

According to the present example embodiment, the moving body includes at least one of a person and a vehicle.

With this, based on the result of the statistical processing, a measure relating to at least one of a person and a vehicle can be taken for safety in a city from a macro perspective. Therefore, it is possible to assist improvement of safety in a city.

According to the present example embodiment, the external appearance information includes the image. The processing unit 103 analyzes the image included in the external appearance information, acquires the external appearance feature value of the moving body, and executes the statistical processing by using the external appearance feature value being acquired.

With this, based on the result of the statistical processing using the external appearance feature value, a measure can be taken for safety in a city from a macro perspective. Therefore, it is possible to assist improvement of safety in a city.

According to the present example embodiment, the processing unit 103 analyzes the image included in the external appearance information, further acquires the attribute of the moving body, and executes the statistical processing by using the attribute of the moving body.

With this, based on the result of the statistical processing further using the attribute of the moving body, a measure can be taken for safety in a city from a macro perspective. Therefore, it is possible to assist improvement of safety in a city.

According to the present example embodiment, the external appearance feature value includes a feature value relating to at least one of an external appearance attribute, a pose, and a movement of the moving body.

With this, based on the result of the statistical processing using a feature value relating to at least one of an external appearance attribute, a pose, and a movement of the moving body, a measure can be taken for safety in a city from a macro perspective. Therefore, it is possible to assist improvement of safety in a city.

According to the present example embodiment, the feature value relating to the movement of the moving body includes at least one of a flow line and a moving speed.

With this, based on the result of the statistical processing using the feature value relating to the movement of the moving body that includes at least one of a flow line and a moving speed, a measure can be taken for safety in a city from a macro perspective. Therefore, it is possible to assist improvement of safety in a city.

According to the present example embodiment, the processing unit 103 executes the statistical processing, based on at least one of the attribute of the location where the image is photographed, the time zone in which the image is photographed, and the attribute of the moving body included in the image.

With this, based on the result of the statistical processing executed based on the attribute of the location where the image is photographed, the time zone in which the image is photographed, or the attribute of the moving body included in the image, a measure can be taken for safety in a city from a macro perspective. Therefore, it is possible to assist improvement of safety in a city.

According to the present example embodiment, the attribute of the location includes at least one of a feature of passage of the moving body and an area.

With this, based on the result of the statistical processing executed based on the attribute of the location including at least one of a feature of passage of the moving body and an area, a measure can be taken for safety in a city from a macro perspective. Therefore, it is possible to assist improvement of safety in a city.

According to the present example embodiment, the processing unit 103 detects the moving body relevant to the event being set in advance, based on the result of analyzing the image included in the external appearance information.

With this, the statistical processing relating to the event can be executed, a measure can be taken for safety in a city from a macro perspective, based on the result of the statistical processing. Further, the event can be detected quickly, and the event can be handled. Therefore, it is possible to assist improvement of safety in a city.

According to the present example embodiment, in a case where the moving body relevant to the notification event being set in advance from the events is detected, the processing unit 103 notifies the notification event of detection of the notification event, the notification destination being decided in advance in association with the notification destination.

With this, a quick response to the notification being detected can be achieved. Therefore, it is possible to assist improvement of safety in a city.

According to the present example embodiment, the processing unit 103 further executes the statistical processing by using the detection result of the moving body relevant to the event being set in advance.

With this, based on the result of the statistical processing relating to the event, a measure can be taken for safety in a city from a macro perspective. Therefore, it is possible to assist improvement of safety in a city.

According to the present example embodiment, the event relates to at least one of a pose, a movement, and an attribute of the moving body.

With this, based on the result of the statistical processing relating to the event relating to at least one of a pose, a movement, and an attribute of the moving body, a measure can be taken for safety in a city from a macro perspective. Alternatively, the event relating to at least one of a pose, a movement, and an attribute of the moving body is detected quickly, and the event can be handled. Therefore, it is possible to assist improvement of safety in a city.

### Second Example Embodiment

In the first example embodiment, description is made on an example in which the monitoring apparatus 101 acquires the external appearance feature value and the attribute of the moving body, detects the event, and issues the notification in a case where the notification event is detected. Acquisition of the external appearance feature value of the moving body, acquisition of the attribute of the moving body, detection of the event, and notification in a case where the notification event is detected may be executed partially or entirely by the terminal 153. In the present example embodiment, description is made on an example in which the terminal 153 executes all of acquisition of the external appearance feature value of the moving body, acquisition of the attribute of the moving body, detection of the event, and notification in a case where the notification event is detected.

In the present example embodiment, for simplification of the description, differences from the first example embodiment are mainly described, and overlapping description is omitted as appropriate.

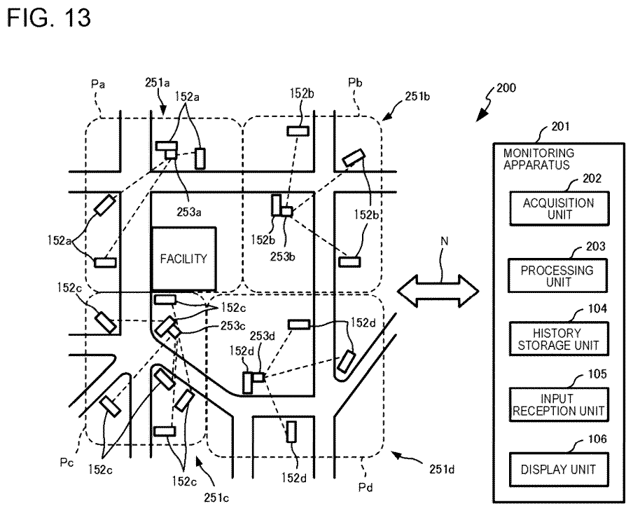

FIG. 13 is a diagram illustrating a configuration example of a monitoring system 200 according to a second example embodiment. The monitoring system 200 includes a monitoring apparatus 201 and four terminal systems 251a to 251d in place of the monitoring apparatus 101 and the four terminal systems 151a to 151d according to the first example embodiment.

### Configuration Example of Terminal System 251

The terminal systems 251a to 251d include the plurality of photographing apparatuses 152a to 152d similar to those in the first example embodiment and terminals 253a to 253d in place of the terminals 153a to 153d according to the first example embodiment, respectively. In a case where the terminal systems 251a to 251d are not distinguished from one another, each of them is also referred to as a terminal system 251.

The terminals 253a to 253d acquire the image information including the image being photographed by each of the photographing apparatuses 152a to 152d, from the plurality of photographing apparatuses 152a to 152d included is the common terminal systems 251a to 251d via the communication line. Each of the terminals 253a to 253d generates the external appearance information, based on the image information being acquired, and it to the monitoring apparatus 201 via the network N.

The terminals 253a to 253d may be configured similarly to one another. In a case where the terminals 253a to 253d are not distinguished from one another, each of them is also referred to as a terminal 253.

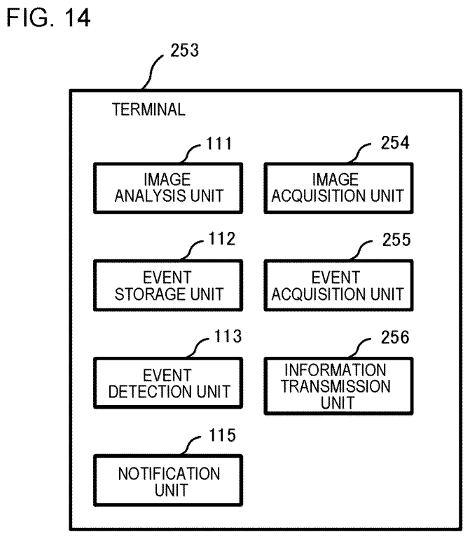

FIG. 14 is a diagram illustrating a functional configuration example of the terminal 253 according to the present example embodiment.

The terminal 253 includes an image acquisition unit 254, the image analysis unit 111, the event storage unit 112, the event detection unit 113, and the notification unit 115 that are similar to those in the first example embodiment, the image acquisition unit 254, an event acquisition unit 255, and an information transmission unit 256.

The image acquisition unit 254 acquires the image information including the image being photographed by each of the photographing apparatuses 152a to 152d, from the plurality of photographing apparatuses 152 included in the common terminal system 251. The image acquisition unit 254 stores an image photographed in at least a predetermined time T1 (for example, five minutes). In other words, the image photographed in the predetermined time T1 in the past prior to the current time is stored.

The image analysis unit 111 analyzes the image photographed by the photographing apparatus 152, similarly to the first example embodiment, and acquires the external appearance feature value and the attribute of the moving body, similarly to the first example embodiment. In other words, In the present example embodiment, the image analysis unit 111 analyzes the image being acquired by the image acquisition unit 254, and acquires the external appearance feature value and the attribute of the moving body, similarly to the first example embodiment.

The event acquisition unit 255 acquires the event information from the monitoring apparatus 201 via the network N, and causes the event storage unit 112 to store the event information being acquired.

Similarly to the first example embodiment, the event detection unit 113 according to the present example embodiment detects the moving body relevant to the event being set in advance from the moving bodies included in the image, based on the result of analyzing the image by the image analysis unit 111 and the event information.

The information transmission unit 256 generates the external appearance information, and transmits, to the monitoring apparatus 201, the external appearance information to the monitoring apparatus 201 via the network N. Further, the information transmission unit 256 transmits the detection information being generated by the event detection unit 113 to the monitoring apparatus 201 via the network N.

Specifically, the information transmission unit 256 generates and transmits first information being external appearance information including the image photographed by the photographing apparatus 152. Moreover, the information transmission unit 256 generates and transmits second information being external appearance information not including the image photographed by the photographing apparatus 152.

The first information includes an image and at least one of an external appearance feature value and an attribute of a moving body acquired from the image. The second information includes at least one of the external appearance feature value and the attribute of the moving body acquired from the common image.

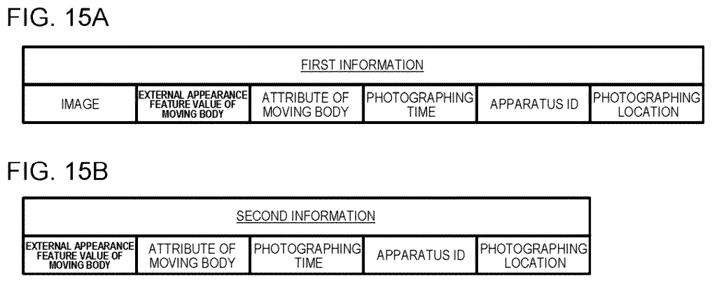

FIG. 15 is a diagram illustrating one example of a configuration of the external appearance information according to the present example embodiment. In FIG. 15, (a) illustrate is an example of the first information. In FIG. 15, (b) illustrate is an example of the second information.

In the first information, the image, an external appearance feature value, an attribute, a photographing time, an apparatus identifier (ID), and a photographing location are associated with one another.

Each of the elements associated with one another in the first information is information relating to the common image being photographed by the photographing apparatus 152. In other words, the image included in the first information is an image photographed by the photographing apparatus 152. The external appearance feature value and the attribute are an external appearance feature value and an attribute that are acquired from the image being associated therewith. The photographing time is a time at which the image associated therewith is photographed. The apparatus ID is information for identifying the photographing apparatus 152 photographing the image associated therewith. The photographing location indicates a location where the image associated therewith is photographed.

In the second information, an external appearance feature value, an attribute, a photographing time, an apparatus identifier (ID), and a photographing location are associated with one another.

Each of the elements associated with one another in the second information is information relating to the common image being photographed by the photographing apparatus 152. In other words, the external appearance feature value and the attribute that are included in the second information are an external appearance feature value and an attribute that are acquired from the common image. The photographing time is a time at which the common image is photographed. The apparatus ID is information for identifying the photographing apparatus 152 photographing the common image. The photographing location indicates a location where the common image is photographed.

The information transmission unit 256 switches a first transmission rate between a high rate and a low rate, according to whether the moving body relevant to the event is detected.

The transmission rate is the number of times for which the information transmission unit 256 transmits information per unit time. The first transmission rate is a transmission rate of the first information, in other words, the number of times for which the information transmission unit 256 transmits the first information per unit time. The high rate is a transmission rate higher than the low rate, in other words, a transmission rate at which information is frequently transmitted per unit time.

The information transmission unit 256 generally transmits the first information at the low rate, and transmits the first information at the high rate in a case where the moving body relevant to the event is detected. More specifically, the information transmission unit 256 transmits the first information at the high rate between the predetermined time T1 before the moving body relevant to the event is detected and a predetermined time T2 after the moving body relevant to the event is detected. Except for the predetermined times T1 and T2 before and after the moving body relevant to the event is detected, the information transmission unit 256 transmits the first information at the low rate.

The information transmission unit 256 transmits the second information at a second transmission rate.

The second transmission rate is a transmission rate of the second information, in other words, the number of times for which the information transmission unit 256 transmits the second information per unit time. The second transmission rate is a transmission rate higher than the low rate. In the present example embodiment, description is made while giving an example in which the second transmission rate is equivalent to the high rate.

In this manner, the information transmission unit 256 generally transmits the second information at the high rate, and transmits the first information at the low rate. In a case where the moving body relevant to the event is detected, the information transmission unit 256 transmits the detection information being generated by the event detection unit 113. Further, for the predetermined times T1 and T2 before and after the moving body relevant to the event is detected, the information transmission unit 256 transmit the first information and the second information at the high rate.

### Configuration Example of Monitoring Apparatus 201

As illustrated in FIG. 13, the monitoring apparatus 201 includes an acquisition unit 202 and a processing unit 203 in place of the acquisition unit 102 and the processing unit 103 according to the first example embodiment, and the history storage unit 104, the input reception unit 105, and the display unit 106 that are similar to those in the first example embodiment, in a functional sense.

The acquisition unit 202 acquires the information being output from the information transmission unit 256, from the terminal 253 via the network N, and causes the history storage unit 104 to store the information being acquired.

Specifically, the acquisition unit 202 according to the present example embodiment acquires the external appearance information (the first information and the second information) being transmitted from the information transmission unit 256, and causes the history storage unit 104 to store the external appearance information (the first information and the second information) being acquired. Further, the acquisition unit 202 acquires the detection information being transmitted from the information transmission unit 256.

Similarly to the first example embodiment, the processing unit 203 executes the statistical processing by using the external appearance information. Further, for example, the processing unit 203 executes the statistical processing, based on at least one of the attribute of the location where the image is photographed, the time zone in which the image is photographed, and the attribute of the moving body included in the image.

The processing unit 203 according to the present example embodiment executes the statistical processing by using at least one of the external appearance feature value and the attribute of the moving body that are included in the external appearance information. The processing unit 203 further executes the statistical processing by using the detection result of the moving body relevant to the event.

The processing unit 203 executes the statistical processing, based on at least one of the attribute of the location where the image is photographed, the time zone in which the image is photographed, and the attribute of the moving body included in the image.

For example, in a case where the event information is acquired according to an input from a user, the processing unit 203 transmits the event information being acquired to the terminal 253 via the network N.

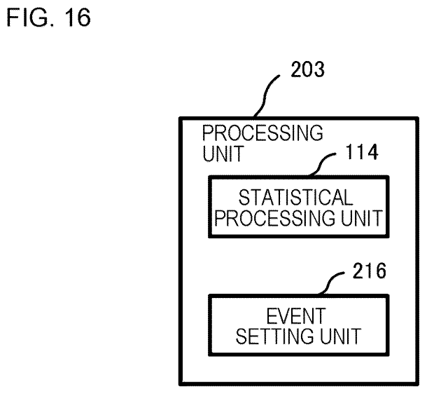

FIG. 16 is a diagram illustrating a functional configuration example of the processing unit 103 according to the present example embodiment. The processing unit 203 includes the statistical processing unit 114 similar to that in the first example embodiment and an event setting unit 216.

For example, the event setting unit 216 receives the event information, according to an input from a user. The event setting unit 216 stores the event information being acquired, and transmits it to the terminal 253 via the network N.

The functional configuration of the monitoring system 200 according to the second example embodiment is mainly described above. In a physical sense, the monitoring system 200 according to the present example embodiment may be configured similarly to the monitoring system 100 according to the first example embodiment. In other words, for example, in a physical sense, the monitoring apparatus 201 and the terminal 253 according to the present example embodiment may be configured similarly to the monitoring apparatus 101 and the terminal 153 according to the first example embodiment, respectively.

Hereinafter, description is made on an operation of the terminal system 251 according to the present example embodiment.

Similarly to the first example embodiment, the photographing apparatus 152 repeatedly executes step S151 and S152 (see FIG. 8).

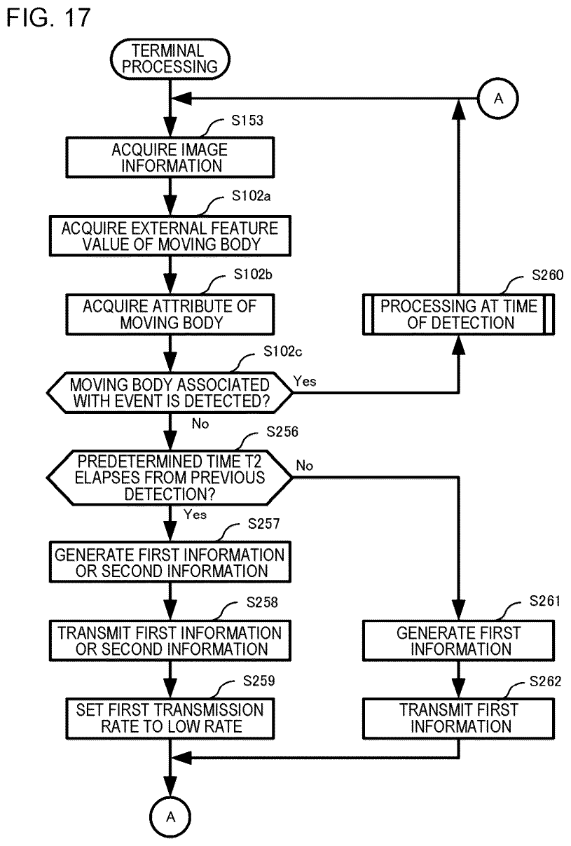

FIG. 17 is a flowchart illustrating one example of terminal processing according to the present example embodiment. The terminal processing is processing to be executed by the terminal 253 for monitoring a city. For example, the processing is started in response to an instruction from a user. For example, the original value of the first transmission rate is the low rate, and is stored in the information transmission unit 256.

The image acquisition unit 254 executes step S153 similar to that in the first example embodiment.

The image analysis unit 111 executes steps S102a and S102b similar to those in the first example embodiment. Similarly to the first example embodiment, the event detection unit 113 decides whether the moving body relevant to the event is detected (step S102c).

In a case where the moving body relevant to the event is not detected (step S102c; No), the information transmission unit 256 decides whether the predetermined time T2 elapses from the previous detection (step S256).

Specifically, for example, the information transmission unit 256 decides whether the predetermined time T2 elapses, based on elapse of time from a timing at which the event detection unit 113 previously detects the moving body relevant to the event. A case in which the predetermined time T2 does not elapse includes a case in which the event detection unit 113 has never detected the moving body relevant to the event.

In a case where the predetermined time T2 elapses (step S256; Yes), the information transmission unit 256 generates the first information or the second information (step S257). The information transmission unit 256 transmits the first information or the second information that is generated in step S257 to the monitoring apparatus 201 via the network N (step S258).

The first information or the second information that are generated in step S257 include the external appearance feature value and the attribute of the moving body that are acquired in steps S102a and S102b. The first information being generated in step S257 further includes the image used for acquiring the external appearance feature value and the attribute of the moving body.

In step S257, the information transmission unit 256 generates any one of the first information and the second information, according to whether it is a transmission time at the high rate (the second transmission rate in the present example embodiment). Specifically, in a case of a transmission time at the low rate, the information transmission unit 256 generates the first information. Except for this case (in other words, in a case where it is the transmission time at the high rate, and it is not the transmission time at the low rate), the information transmission unit 256 generates the second information.

With this, the information transmission unit 256 can generate and transmit the first information at the low rate. Further, the information transmission unit 256 can generate and transmit the second information at the high rate.

The information transmission unit 256 sets the low rate to the first transmission rate (step S259), and returns to step S153.

In a case where the moving body relevant to the event is detected (step S102c; Yes), the event detection unit 113 executes processing at the time of detection (step S260).

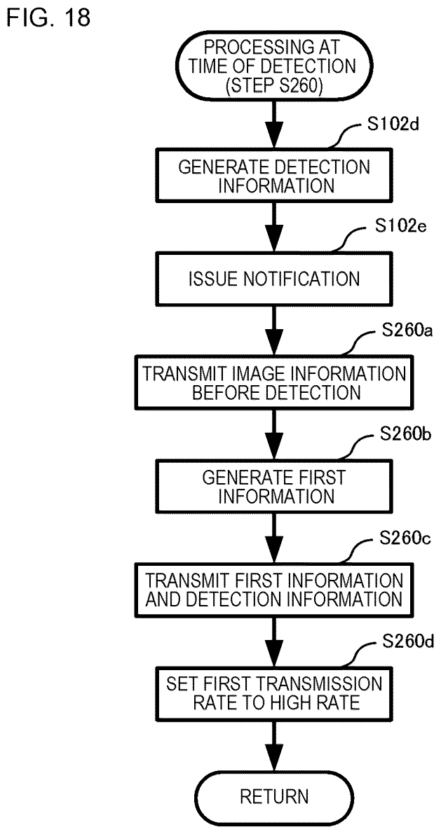

FIG. 18 is a flowchart illustrating a detailed example of the processing (step S260) at the time of detection according to the present example embodiment.

The event detection unit 113 executes step S102d similar to that in the first example embodiment. The notification unit 115 executes step S102e similar to that in the first example embodiment.

The information transmission unit 256 transmits the image information before detection (step S260a)

Specifically, the information transmission unit 256 acquires, from the image acquisition unit 254, the image information including the image that is stored in the image acquisition unit 254 and is photographed in the predetermined time T1 in the past. The information transmission unit 256 transmits the image information being acquired to the monitoring apparatus 201 via the network N.

The information transmission unit 256 generates the first information (step S260b).

The first information being generated in step S260b is similar to the first information being generated in step S257.

The information transmission unit 256 transmits the first information and the detection information (step S260c).

Specifically, the information transmission unit 256 transmits the first information being generated in step S260b and the detection information being generated in step S102d to the monitoring apparatus 201 via the network N.

The information transmission unit 256 sets the high rate to the first transmission rate (step S258), an returns to step S153 (see FIG. 17).

Refer back to FIG. 17.

In a case where the predetermined time T2 does not elapse (step S256; No), the information transmission unit 256 generates the first information (step S261). The first information being generated in step S261 is similar to the first information being generated in step S258. The information transmission unit 256 transmits the first information being generated in step S261 to the monitoring apparatus 201 via the network N (step S262), and returns to step S153.

Step S261 and S262 are executed within the predetermined time T2 from a timing at which the moving body relevant to the event is detected, and hence are executed after step S260d. Thus, the transmission rate being set for executing steps S261 and S262 is the high rate. The information transmission unit 256 executes step S261 and S262, according to the transmission time at the high rate being the first transmission rate being set. With this, the information transmission unit 256 can transmit the first information at the high rate until the predetermined time T2 elapses from a timing at which the moving body relevant to the event is detected.

By executing the terminal processing, the terminal 253 can generally transmit the first information at the low rate, and can transmit the first information at the high rate in a case where the moving body relevant to the event is detected. The first information includes the image, and hence has a data size larger than the second information. Thus, a communication load on the network N can be reduced as compared to a case in which the first information is transmitted at the high rate all the time.

Further, the monitoring apparatus 201 can acquire the first information including the image at the low rate. Thus, the image can be confirmed as required. In a case where the moving body relevant to the event is detected, the monitoring apparatus 201 can acquire the first information. Thus, the images before and after detection of the moving body can be managed, and a detailed image can be confirmed as required.

Moreover, the terminal 253 transmits the second information at the second transmission rate (in the present example embodiment, the high rate) that is a transmission rate higher than the low rate. Thus, the monitoring apparatus 201 can execute the statistical processing, based on the external appearance information and the attribute of the moving body that are acquired at the high transmission rate. With this, the result of the statistical processing can be acquired at the accuracy substantially equivalent to that in the first example embodiment.

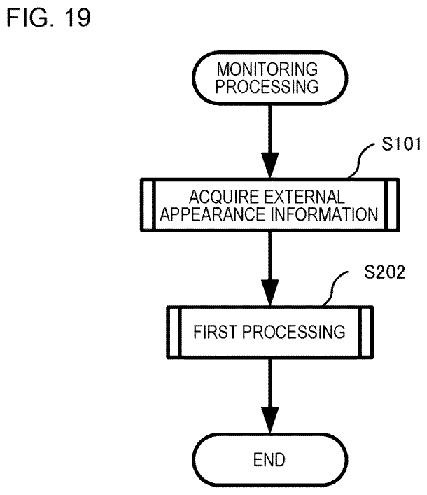

FIG. 19 is a flowchart illustrating one example of the monitoring processing according to the present example embodiment. The acquisition unit 102 executes step S101 similar to that in the first example embodiment. The processing unit 203 executes step S202 in place of step S102 according to the first example embodiment.

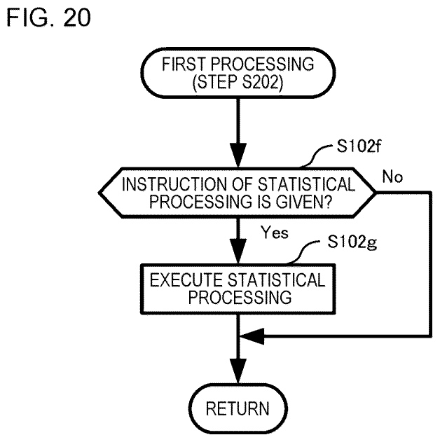

FIG. 20 is a flowchart illustrating a detailed example of the first processing according to the present example embodiment (step S202). The statistical processing unit 114 executes steps S102f and S102g similar to those in the first example embodiment.

### Advantageous Effects

According to the present example embodiment, the external appearance information includes the external appearance feature value of the moving body.

With this, the monitoring apparatus 201 can execute the statistical processing by using the external appearance feature value of the moving body, and hence a measure can be taken for safety in a city from a macro perspective, based on the result of the statistical processing. Therefore, it is possible to assist improvement of safety in a city.

Further, it is not required to include the image in the external appearance information in order to execute the statistical processing using the external appearance feature value of the moving body, and hence a communication load on the network N can be reduced.

According to the present example embodiment, the external appearance information further includes the attribute of the moving body.

With this, the monitoring apparatus 201 can execute the statistical processing by using the attribute of the moving body, and hence a measure can be taken for safety in a city from a macro perspective, based on the result of the statistical processing. Therefore, it is possible to assist improvement of safety in a city.

Further, it is not required to include the image in the external appearance information in order to execute the statistical processing using the attribute of the moving body, and hence a communication load on the network N can be reduced.

According to the present example embodiment, the acquisition unit 202 further acquires the detection information indicating the detection result of the moving body relevant to the event being set in advance.

With this, the monitoring apparatus 201 can execute the statistical processing relating to the event, and hence a measure can be taken for safety in a city from a macro perspective, based on the result of the statistical processing. Therefore, it is possible to assist improvement of safety in a city.

Further, it is not required to transmit the image in order to execute the statistical processing relating to the event, and hence a communication load on the network N can be reduced.

According to the present example embodiment, the monitoring apparatus 201 further includes the event setting unit 216 that transmits the event information relating to the event being set in advance to the terminal 253.

With this, the common event information can be set to all the one or more terminals 253 via the monitoring apparatus 201, and hence time and labor for setting the event information to each of the one or more terminals 253 can be reduced. Therefore, it is possible to easily assist improvement of safety in a city.

### Third Example Embodiment

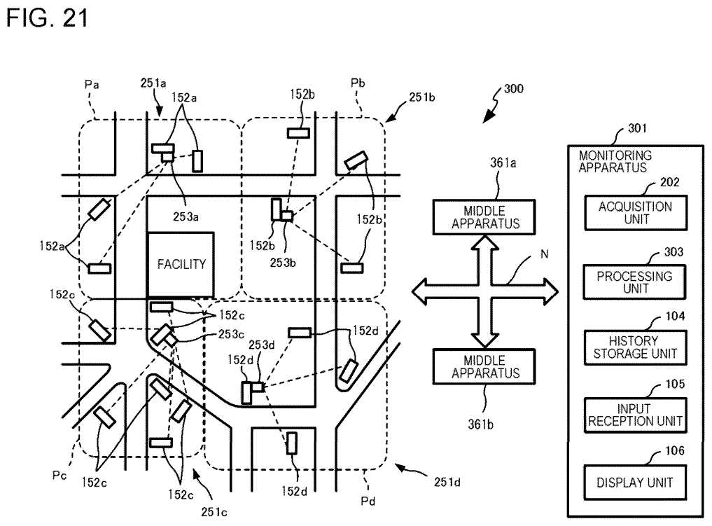

FIG. 21 is a diagram illustrating a configuration example of a monitoring system 300 according to a third example embodiment. The monitoring system 300 includes a monitoring apparatus 301 in place of the monitoring apparatus 201 according to the second example embodiment, the terminal systems 251a to 251d similar to those in the second example embodiment, and two middle apparatuses 361a and 361b. Note that, the number of middle apparatuses included in the monitoring system 300 is not limited to two, and may be any number as long as it is one or more.

The middle apparatuses 361a and 361b are connected to the monitoring apparatus 301 and each of the terminals 253a to 253d via the network N, and mutually transmit and receive information via the network N.

Each of the middle apparatuses 361a and 361b is associated with the one or plurality of terminal systems 251. In other words, each of the middle apparatuses 361a and 361b is located between the terminals 253a to 253d and the monitoring apparatus 301 on the network N.

The middle apparatuses 361a and 361b may be configured similarly to one another. In a case where the middle apparatuses 361a and 361b are not distinguished from one another, each of them is also referred to as a middle apparatus 361.

The middle apparatus 361 is an apparatus used at a predetermined institution such as the police. In other words, the middle apparatus 361 is an example of the apparatus to which the notification unit 115 transmits the detection information.

The middle apparatus 361 transmits, to the monitoring apparatus 301 via the network N, dispatch information relating to dispatch in a case of the dispatch from the institution.

The monitoring apparatus 301 includes a processing unit 303 in place of the processing unit 203 according to the second example embodiment. Except for this point, the monitoring apparatus 301 may be configured similarly to the monitoring apparatus 201 according to the second example embodiment.

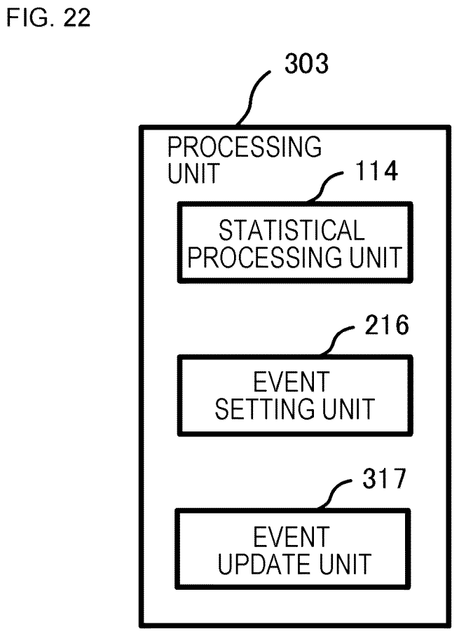

FIG. 22 is a diagram illustrating a functional configuration example of the processing unit 303 according to the present example embodiment. The processing unit 303 includes the statistical processing unit 114 and the event setting unit 216 that are similar to those in the second example embodiment, and an event update unit 317.

The event update unit 317 acquires the dispatch information from the middle apparatus 361. The event update unit 317 transmits, to the terminal 253 via the network N, update information for updating the event information, based on the dispatch information being acquired.

The functional configuration of the monitoring system 300 according to the third example embodiment is mainly described above. In a physical sense, the monitoring apparatus 301 and each of the middle apparatus 361 according to the present example embodiment may be configured similarly to the monitoring apparatus 101 according to the first example embodiment.

Hereinafter, description is made on an operation of the monitoring system 300 according to the present example embodiment.

The monitoring system 300 according to the present example embodiment executes event update processing for updating the event information, in addition to the processing similar to that in the second example embodiment.

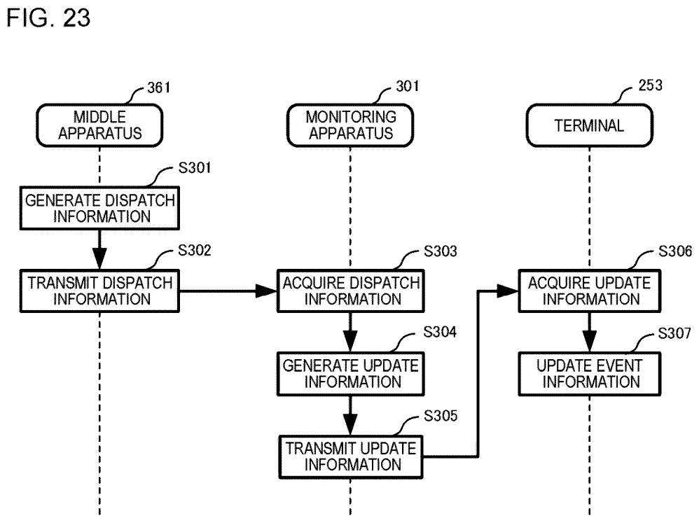

FIG. 23 is a flowchart illustrating one example of the event update processing according to the present example embodiment. For example, the event update processing is repeatedly executed during the operation of the monitoring system 300.

In a case of the dispatch from the institution, the middle apparatus 361 generates the dispatch information relating to the dispatch (step S301).

Specifically, for example, the middle apparatus 361 generates the dispatch information including a dispatch time, a departure location, a destination location, an event, and the like. The dispatch time is a time of the dispatch. The departure location is a location of the institution being dispatched. The destination location is a destination of the dispatch. The event is an event causing the dispatch.

The middle apparatus 361 transmits the dispatch information being generated in step S301 to the monitoring apparatus 301 via the network N (step S302).

The event update unit 317 acquires the dispatch information from the middle apparatus 361 (step S303).

The event update unit 317 generates the update information for updating the event information, based on the dispatch information being acquired in step S303 (step S304).

Specifically, for example, in a case where the event detection unit 113 does not detect the event relating to the dispatch information, the event update unit 317 refers to at least one of the image of the destination location included in the dispatch information, and the external appearance information and the attribute of the moving body that are acquired from the image.

The event update unit 317 generates the detection condition for detecting the event included in the dispatch information by the event detection unit 113, based on at least one of the image being referred to, and the external appearance information and the attribute of the moving body. For example, the detection condition includes at least one of the image being referred to, and the external appearance information and the attribute of the moving body. The event update unit 317 generates the update information in which the event associated with the dispatch information and the detection condition being generated are associated with each other.

The event update unit 317 transmits the update information being generated in step S304 to the terminal 253 via the network N (step S305).

The event acquisition unit 255 acquires the update information (step S306). The event acquisition unit 255 updates the event information being stored in the event storage unit 112, based on the update information being acquired in step S306 (step S307).

With this, in a case where the event detection unit 113 cannot detect the event, the event information can be updated based on at least one of the image relating to the event that actually occurs, and the external appearance information and the attribute of the moving body.

### Advantageous Effects

According to the present example embodiment, the terminal 253 transmits the detection information relating to the moving body being detected to the middle apparatus 361.

With this, the monitoring apparatus 301 is capable of executing the statistical processing by using the external appearance feature value of the moving body, and hence a measure can be taken for safety in a city from a macro perspective, based on the result of the statistical processing. Therefore, it is possible to assist improvement of safety in a city.

With this, a quick response to the notification being detected can be achieved. Therefore, it is possible to assist improvement of safety in a city.

According to the present example embodiment, the middle apparatus 361 is an apparatus used at a predetermined institution. The monitoring apparatus 301 further includes the event update unit 317 that acquires the dispatch information relating to the dispatch in a case of the dispatch from the institution, and transmits, to the terminal 253, the update information for updating the event information, based on the dispatch information being acquired.

With this, in a case where the event detection unit 113 cannot detect the event, the event information can be updated, and hence the event information can be updated in such a way that the event can be detected at higher accuracy. Therefore, it is possible to assist improvement of safety in a city.

While the example embodiments and the modification examples of the present invention have been described with reference to the drawings, those are merely exemplification of the present invention, and various configurations other than those described above can also be employed.

Further, in the plurality of flowcharts used in the description given above, a plurality of steps (pieces of processing) are described in order, but the execution order of the steps executed in each of the example embodiments is not limited to the described order. In each of the example embodiments, the order of the illustrated steps may be changed without interfering with the contents. Further, the example embodiments and the modification examples described above may be combined with each other within a range where the contents do not conflict with each other.

The whole or a part of the example embodiments described above can be described as, but not limited to, the following supplementary notes.

1. A monitoring apparatus including:
an acquisition unit that acquires external appearance information relating to an external appearance of a moving body included in an image captured by a plurality of photographing apparatuses installed in a city; and
a processing unit that executes statistical processing by using the external appearance information.

2. The monitoring apparatus according to supplementary note 1, wherein
the moving body includes at least one of a person and a vehicle.

3. The monitoring apparatus according to supplementary note 1 or 2, wherein
the external appearance information includes the image, and
the processing unit acquires an external appearance feature value of the moving body by analyzing an image included in the external appearance information, and executes statistical processing by using the external appearance feature value being acquired.

4. The monitoring apparatus according to supplementary note 3, wherein
the processing unit further acquires an attribute of the moving body by analyzing the image included in the external appearance information, and further executes statistical processing by using the attribute of the moving body.

5. The monitoring apparatus according to supplementary note 1 or 2, wherein
the external appearance information includes an external appearance feature value of the moving body.

6. The monitoring apparatus according to supplementary note 5, wherein
the external appearance information further includes an attribute of the moving body.

7. The monitoring apparatus according to any one of supplementary notes 3 to 6, wherein
the external appearance feature value includes a feature value relating to at least one of an external appearance attribute, a pose, and a movement of the moving body.

8. The monitoring apparatus according to supplementary note 7, wherein
the feature value relating to the movement of the moving body includes at least one of a flow line and a moving speed.

9. The monitoring apparatus according to any one of supplementary notes 1 to 8, wherein
the processing unit executes the statistical processing, based on at least one of an attribute of a location at which the image is captured, a time zone in which the image is captured, and an attribute of a moving body included in the image.

10. The monitoring apparatus according to supplementary note 9, wherein
the attribute of the location includes at least one of a feature of passage of the moving body and an area.

11. The monitoring apparatus according to any one of supplementary notes 1 to 10, wherein
the processing unit detects a moving body relevant to an event being set in advance, based on a result of analyzing the image included in the external appearance information.

12. The monitoring apparatus according to supplementary note 11, wherein
in a case where a moving body relevant to a notification event being decided in advance is detected from the event, the processing unit notifies a notification destination of detection of the notification event, the notification destination being decided in advance in association with the notification event.

13. The monitoring apparatus according to any one of supplementary notes 1 to 10, wherein
the acquisition unit further acquires detection information indicating a detection result of a moving body relevant to an event being set in advance.

14. The monitoring apparatus according to supplementary note 13, further including:
an event setting unit that transmits, to a terminal, event information relating to the event being set in advance.

15. The monitoring apparatus according to any one of supplementary notes 11 to 14, wherein
the processing unit further executes statistical processing by using a detection result of a moving body relevant to the event being set in advance.

16. The monitoring apparatus according to any one of supplementary notes 11 to 15, wherein
the event relates to at least one of a pose, a movement, an attribute of a moving body.

17. A monitoring system including:
the monitoring apparatus according to any one of supplementary notes 1 to 16;
the plurality of photographing apparatuses; and
at least one terminal to be connected to the plurality of photographing apparatuses, wherein
the terminal transmits the external appearance information to the monitoring apparatus.

18. The monitoring system according to supplementary note 17, wherein
the terminal acquires an external appearance feature value of the moving body by analyzing the image, and transmits, to the monitoring apparatus, the external appearance information including the external appearance feature value being acquired.

19. The monitoring system according to supplementary note 17 or 18, wherein
the terminal further acquires an attribute of the moving body by analyzing the image, and transmits, to the monitoring apparatus, the external appearance information further including the attribute of the moving body that is acquired.

20. The monitoring system according to any one of supplementary notes 17 to 19, wherein
the external appearance information includes an image being captured by the plurality of photographing apparatuses.

21. The monitoring system according to any one of supplementary notes 17 to 20, wherein
the terminal acquires, from the monitoring apparatus, event information relating to an event being set in advance, and detects a moving body relevant to the event, based on a result of analyzing the image.

22. The monitoring system according to supplementary note 21, wherein
the terminal transmits, to the monitoring apparatus, detection information relating to the moving body being detected.

23. The monitoring system according to supplementary note 21 or 22, further including:
at least one middle apparatus, wherein
the terminal transmits, to the middle apparatus, detection information relating to the moving body being detected.

24. The monitoring system according to supplementary note 23, wherein
the middle apparatus is an apparatus being used at a predetermined institution, and
the monitoring apparatus further includes an event update unit that acquires dispatch information relating to dispatch in a case of the dispatch from the institution, and transmits, to the terminal, update information for updating the event information, based on the dispatch information being acquired.

25. A monitoring method including,
by a computer executing:
   acquiring external appearance information relating to an external appearance of a moving body included in an image captured by a plurality of photographing apparatuses installed in a city; and
   executing statistical processing by using the external appearance information.

26. A storage medium configured to store a program for causing a computer to:
acquire external appearance information relating to an external appearance of a moving body included in an image captured by a plurality of photographing apparatuses installed in a city; and
execute statistical processing by using the external appearance information.

27. A program for causing a computer to:
acquire external appearance information relating to an external appearance of a moving body included in an image captured by a plurality of photographing apparatuses installed in a city; and
execute statistical processing by using the external appearance information.

### REFERENCE SIGNS LIST

100, 200, 300 Monitoring system
101, 201, 301 Monitoring apparatus
102, 202 Acquisition unit
103, 203, 303 Processing unit
104 History storage unit
105 Input reception unit
106 Display unit
111 Image analysis unit
112 Event storage unit
113 Event detection unit
114 Statistical processing unit
115 Notification unit
151, 151a to 151d, 251, 251a to 251d Terminal system
152, 152a to 152d Photographing apparatus
153, 153a to 153d, 253, 253a to 253d Terminal
216 Event setting unit
254 Image acquisition unit
255 Event acquisition unit
256 Information transmission unit
317 Event update unit
361, 361a to 361b Middle apparatus

What is claimed is:

1. A monitoring apparatus comprising:
at least one memory configured to store instructions; and
at least one processor configured to execute the instructions to:
acquire external appearance information relating to an external appearance of a moving body included in an image captured by a plurality of photographing apparatuses installed in a city; and
execute statistical processing by using the external appearance information.

2. The monitoring apparatus according to claim 1, wherein
the moving body includes at least one of a person and a vehicle.

3. The monitoring apparatus according to claim 1, wherein
the external appearance information includes the image, and
the at least one processor configured further to execute the instructions to:
acquire an external appearance feature value of the moving body by analyzing the image included in the external appearance information; and
execute the statistical processing by using the external appearance feature value being acquired.

4. The monitoring apparatus according to claim 3, wherein
the at least one processor configured further to execute the instructions to:
acquire an attribute of the moving body by analyzing the image included in the external appearance information; and
execute the statistical processing by further using the attribute of the moving body.

5. The monitoring apparatus according to claim 1, wherein
the external appearance information includes an external appearance feature value of the moving body.

6. The monitoring apparatus according to claim 5, wherein
the external appearance information further includes an attribute of the moving body.

7. The monitoring apparatus according to claim 3, wherein
the external appearance feature value includes a feature value relating to at least one of an external appearance attribute, a pose, and a movement of the moving body.

8. The monitoring apparatus according to claim 7, wherein
the feature value relating to the movement of the moving body includes at least one of a flow line and a moving speed.

9. The monitoring apparatus according to claim 8, wherein the at least one processor configured further to execute the instructions to:
execute the statistical processing, based on at least one of an attribute of a location at which the image is captured, a time zone in which the image is captured, and an attribute of a moving body included in the image.

10. The monitoring apparatus according to claim 9, wherein
the attribute of the location includes at least one of a feature of passage of the moving body and an area.

11. The monitoring apparatus according to claim 1, the at least one processor configured further to execute the instructions to:
detect a moving body relevant to an event being set in advance, based on a result of analyzing the image included in the external appearance information.

12. The monitoring apparatus according to claim 11, the at least one processor configured further to execute the instructions to:
in a case where a moving body relevant to a notification event being decided in advance is detected from the event, notify a notification destination of detection of the notification event, the notification destination being decided in advance in association with the notification event.

13. The monitoring apparatus according to claim 1, the at least one processor configured further to execute the instructions to:
acquire detection information indicating a detection result of a moving body relevant to an event being set in advance.

14. The monitoring apparatus according to claim 13, the at least one processor configured further to execute the instructions to:
transmit, to a terminal, event information relating to the event being set in advance.

15. The monitoring apparatus according to claim 11, the at least one processor configured further to execute the instructions to:
execute the statistical processing by using a detection result of a moving body relevant to the event being set in advance.

16. The monitoring apparatus according to claim 11, wherein
the event relates to at least one of a pose, a movement, an attribute of a moving body.

17. A monitoring system comprising:
the monitoring apparatus according to claim 1; and
at least one terminal to be connected to the plurality of photographing apparatuses, wherein the at least one terminal comprises:
at least one processor configures to cause to:
transmit the external appearance information to the monitoring apparatus.

18-20. (canceled)

21. The monitoring system according to claim 17, further comprising:
at least one middle apparatus being used at a predetermined institution, wherein
the terminal acquires detect a moving body relevant to an event, based on event information relating to the event being set in advance and a result of analyzing the image, and transmits, to the middle apparatus, detection information relating to the moving body being detected,
the at least one processor comprised in the monitoring apparatus configured to execute the instructions to:
acquire dispatch information relating to dispatch in a case of the dispatch from the institution, and
transmit, to the terminal, update information for updating the event information, based on the dispatch information being acquired.

22-24. (canceled)

25. A monitoring method comprising,
by a computer executing:
acquiring external appearance information relating to an external appearance of a moving body included in an image captured by a plurality of photographing apparatuses installed in a city; and
executing statistical processing by using the external appearance information.

26. A non-transitory computer readable storage-medium configured to store a program for causing a computer to:
acquire external appearance information relating to an external appearance of a moving body included in an image captured by a plurality of photographing apparatuses installed in a city; and
execute statistical processing by using the external appearance information.
